(19) United States
(12) Patent Application Publication
(10) Pub. No.: US 2020/0371592 A1
(43) Pub. Date: Nov. 26, 2020

(54) SENSING AND COMPENSATING FOR NON-LINEAR HAPTIC VIBRATION

(71) Applicant: Cirrus Logic International Semiconductor Ltd., Edinburgh (GB)

(72) Inventor: John L. MELANSON, Austin, TX (US)

(73) Assignee: Cirrus Logic International Semiconductor Ltd., Edinburgh (GB)

(21) Appl. No.: 16/694,010

(22) Filed: Nov. 25, 2019

Related U.S. Application Data
(60) Provisional application No. 62/851,232, filed on May 22, 2019.

(51) Int. Cl. G06F 3/01; F16F 15/04; G08B 6/00; G08B 29/24

(52) U.S. Cl. CPC G06F 3/016; G08B 29/24; G08B 6/00; F16F 15/04

(57) ABSTRACT

A method may include determining whether an electronic device having a haptic transducer is in an undesired noise-generating position and responsive to the electronic device being in the undesired noise-generating position, modifying playback of a haptic effect at the haptic transducer.

### RELATED APPLICATION

The present disclosure claims priority to U.S. Provisional Patent Application Ser. No. 62/851,232, filed May 22, 2019, which is incorporated by reference herein in its entirety.

### FIELD OF DISCLOSURE

The present disclosure relates in general to electronic devices with user interfaces (e.g., mobile devices, game controllers, instrument panels, etc.), and more particularly, a haptic system for use in a system for mechanical button replacement in a mobile device, for use in haptic feedback for capacitive sensors, and/or other suitable applications.

### BACKGROUND

Linear resonant actuators (LRAs) and other vibrational actuators (e.g., rotational actuators, vibrating motors, etc.) are increasingly being used in mobile devices (e.g., mobile phones, personal digital assistants, video game controllers, etc.) to generate vibrational feedback for user interaction with such devices. Typically, a force/pressure sensor detects user interaction with the device (e.g., a finger press on a virtual button of the device) and in response thereto, the linear resonant actuator vibrates to provide feedback to the user. For example, a linear resonant actuator may vibrate in response to force to mimic to the user the feel of a mechanical button click.

With appropriate design of input signal to an LRA, certain forms of vibration patterns may be generated, and specific haptic effects may be perceived by a user. Among such haptic application scenarios, one important type of haptic notification is generation of a button click (or virtual switch) effect, in which natural, sharp, and clear-cut haptic perceptions generated by the LRA that mimic the clicks of a true mechanical button are desirable.

Typically, it is desired that haptic effects are inaudible, as the general desire is for haptic effects to provide tactile sensations. However, when haptic effects are provided or played by an electronic device, there may be instances in which haptic effects cause undesirable audible output.

An example of such an occurrence of undesired audio output may be when an electronic device rests loosely on a hard surface, such as a flat table. If the acceleration of the phone (e.g., due to a playback of a haptic effect) is sufficient, the phone will alternately stick and slide on the surface. The non-linear change of modes will modify some of the vibrational energy to higher-frequencies, and a “buzzing” sound may be audible.

Another example of such an occurrence may be when a phone is in a user's pocket with other items, such as keys. The haptic effect may cause the phone to bounce off the keys at a haptic frequency, and the bound non-linearity may cause some of the energy to be translated to an audible frequency.

Accordingly, there is a need and desire to overcome such shortcomings and disadvantages of how haptic effects are provided or played back to minimize or eliminate audible sounds from being generated from haptic output.

### SUMMARY

In accordance with the teachings of the present disclosure, the disadvantages and problems associated with generating haptic feedback in a mobile device may be reduced or eliminated.

In accordance with embodiments of the present disclosure, a method may include determining whether an electronic device having a haptic transducer is in an undesired noise-generating position and responsive to the electronic device being in the undesired noise-generating position, modifying playback of a haptic effect at the haptic transducer.

In accordance with these and other embodiments of the present disclosure, a system may include an input configured to receive an indication of whether an electronic device having a haptic transducer is in an undesired noise-generating position and control circuitry configured to determine whether the electronic device is in an undesired noise-generating position and responsive to the electronic device being in the undesired noise-generating position, modify playback of a haptic effect at the haptic transducer.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example mobile device, in accordance with embodiments of the present disclosure;

FIG. 2 illustrates an electronic device being held in hand by a user, in accordance with embodiments of the present disclosure;

FIG. 3 illustrates an electronic device resting on a table, in accordance with embodiments of the present disclosure;

FIG. 4 illustrates an electronic device located in proximity to keys in the pocket of a user's clothing, in accordance with embodiments of the present disclosure; and

FIG. 5 illustrates a flow chart of an example method for sensing and compensating for non-linear haptic vibration, in accordance with embodiments of the present disclosure.

### DETAILED DESCRIPTION

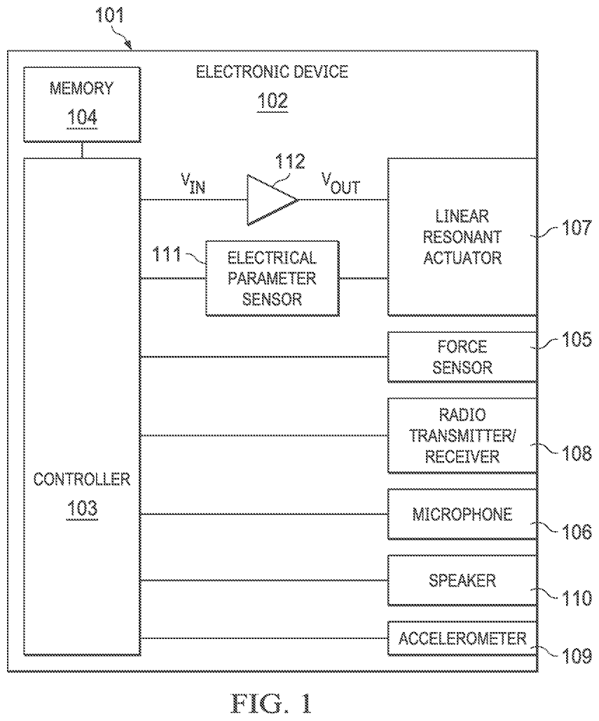

FIG. 1 illustrates a block diagram of selected components of an example electronic device 102, in accordance with embodiments of the present disclosure. As shown in FIG. 1, electronic device 102 may comprise an enclosure 101, a controller 103, a memory 104, a force sensor 105, a microphone 106, a linear resonant actuator 107, an amplifier 112, a radio transmitter/receiver 108, an accelerometer 109, a speaker 110, and an electrical parameter sensor 111.

Enclosure 101 may comprise any suitable housing, casing, or other enclosure for housing the various components of electronic device 102. Enclosure 101 may be constructed from plastic, metal, and/or any other suitable materials. In addition, enclosure 101 may be adapted (e.g., sized and shaped) such that electronic device 102 is readily transported on a person of a user of electronic device 102. Accordingly, electronic device 102 may include but is not limited to a smart phone, a tablet computing device, a handheld computing device, a personal digital assistant, a notebook computer, a video game controller, or any other device that may be readily transported on a person of a user of electronic device 102.

Controller 103 may be housed within enclosure 101 and may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, controller 103 interprets and/or executes program instructions and/or processes data stored in memory 104 and/or other computer-readable media accessible to controller 103.

Memory 104 may be housed within enclosure 101, may be communicatively coupled to controller 103, and may include any system, device, or apparatus configured to retain program instructions and/or data for a period of time (e.g., computer-readable media). Memory 104 may include random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to electronic device 102 is turned off.

Microphone 106 may be housed at least partially within enclosure 101, may be communicatively coupled to controller 103, and may comprise any system, device, or apparatus configured to convert sound incident at microphone 106 to an electrical signal that may be processed by controller 103, wherein such sound is converted to an electrical signal using a diaphragm or membrane having an electrical capacitance that varies as based on sonic vibrations received at the diaphragm or membrane. Microphone 106 may include an electrostatic microphone, a condenser microphone, an electret microphone, a microelectromechanical systems (MEMs) microphone, or any other suitable capacitive microphone.

Radio transmitter/receiver 108 may be housed within enclosure 101, may be communicatively coupled to controller 103, and may include any system, device, or apparatus configured to, with the aid of an antenna, generate and transmit radio-frequency signals as well as receive radio-frequency signals and convert the information carried by such received signals into a form usable by controller 103. Radio transmitter/receiver 108 may be configured to transmit and/or receive various types of radio-frequency signals, including without limitation, cellular communications (e.g., 2G, 3G, 4G, LTE, etc.), short-range wireless communications (e.g., BLUETOOTH), commercial radio signals, television signals, satellite radio signals (e.g., GPS), Wireless Fidelity, etc.

A speaker 110 may be housed at least partially within enclosure 101 or may be external to enclosure 101, may be communicatively coupled to controller 103, and may comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap. When an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

Force sensor 105 may be housed within enclosure 101, and may include any suitable system, device, or apparatus for sensing a force, a pressure, or a touch (e.g., an interaction with a human finger) and generating an electrical or electronic signal in response to such force, pressure, or touch. In some embodiments, such electrical or electronic signal may be a function of a magnitude of the force, pressure, or touch applied to the force sensor. In these and other embodiments, such electronic or electrical signal may comprise a general purpose input/output signal (GPIO) associated with an input signal to which haptic feedback is given (e.g., a capacitive touch screen sensor or other capacitive sensor to which haptic feedback is provided). For purposes of clarity and exposition in this disclosure, the term “force” as used herein may refer not only to force, but to physical quantities indicative of force or analogous to force, such as, but not limited to, pressure and touch.

Amplifier 112 may be electrically coupled to controller 103 and may comprise any suitable electronic system, device, or apparatus configured to increase the power of an input signal V_{IN} (e.g., a time-varying voltage or current) to generate an output signal V_{OUT}. For example, amplifier 112 may use electric power from a power supply (not explicitly shown) to increase the amplitude of a signal. Amplifier 112 may include any suitable amplifier class, including without limitation, a Class-D amplifier.

Linear resonant actuator 107 may be housed within enclosure 101, and may include any suitable system, device, or apparatus for producing an oscillating mechanical force across a single axis. For example, in some embodiments, linear resonant actuator 107 may rely on an alternating current voltage to drive a voice coil pressed against a moving mass connected to a spring. When the voice coil is driven at the resonant frequency of the spring, linear resonant actuator 107 may vibrate with a perceptible force. Thus, linear resonant actuator 107 may be useful in haptic applications within a specific frequency range. While, for the purposes of clarity and exposition, this disclosure is described in relation to the use of linear resonant actuator 107, it is understood that any other type or types of vibrational actuators (e.g., eccentric rotating mass actuators) may be used in lieu of or in addition to linear resonant actuator 107. In addition, it is also understood that actuators arranged to produce an oscillating mechanical force across multiple axes may be used in lieu of or in addition to linear resonant actuator 107. As described elsewhere in this disclosure, a linear resonant actuator 107, based on a signal received from controller 103 and amplified by amplifier 112, may render haptic feedback to a user of electronic device 102 for at least one of mechanical button replacement and capacitive sensor feedback.

Accelerometer 109 may be communicatively coupled to controller 103, and may include any system, device, or apparatus configured to measure an acceleration (e.g., proper acceleration) generated by linear resonant actuator 107 and/or an acceleration experienced by electronic device 102 and generate an acceleration response signal indicative of such measured acceleration.

Electrical parameter sensor 111 may be communicatively coupled to controller 103 and linear resonant actuator 107 and may comprise any suitable system, device, or apparatus configured to measure one or more electrical parameters (e.g., current through linear resonance actuator 107, voltage across linear resonance actuator 107, etc.) associated with linear resonant actuator 107.

Although specific example components are depicted above in FIG. 1 as being integral to electronic device 102 (e.g., controller 103, memory 104, force sensor 105, microphone 106, radio transmitter/receiver 108, accelerometer 109, speaker(s) 110, electrical parameter sensor 111, amplifier 112), an electronic device 102 in accordance with this disclosure may comprise one or more components not specifically enumerated above. For example, although FIG. 1 depicts certain user interface components, electronic device 102 may include one or more other user interface components in addition to those depicted in FIG. 1, including but not limited to a keypad, a touch screen, and a display, thus allowing a user to interact with and/or otherwise manipulate electronic device 102 and its associated components.

In operation, controller 103 may receive a signal from force sensor 105 indicative of a force applied to electronic device 102 (e.g., a force applied by a human finger to a virtual button of electronic device 102) and may generate an electronic signal for driving linear resonant actuator 107 in response to the force applied to electronic device 102.

To that end, memory 104 may store one or more haptic playback waveforms. In some embodiments, each of the one or more haptic playback waveforms may define a haptic response a(t) as a desired acceleration of a linear resonant actuator (e.g., linear resonant actuator 107) as a function of time. Controller 103 may be configured to receive a force signal from force sensor 105 indicative of force applied to force sensor 105. Either in response to receipt of a force signal indicating a sensed force or independently of such receipt, controller 103 may retrieve a haptic playback waveform from memory 104 and process such haptic playback waveform to determine a processed haptic playback signal V_{IN}. In embodiments in which amplifier 112 is a Class D amplifier, processed haptic playback signal V_{IN} may comprise a pulse-width modulated signal. In response to receipt of a force signal indicating a sensed force, controller 103 may cause processed haptic playback signal V_{IN} to be output to amplifier 112, and amplifier 112 may amplify processed haptic playback signal V_{IN} to generate a haptic output signal V_{OUT} for driving linear resonant actuator 107.

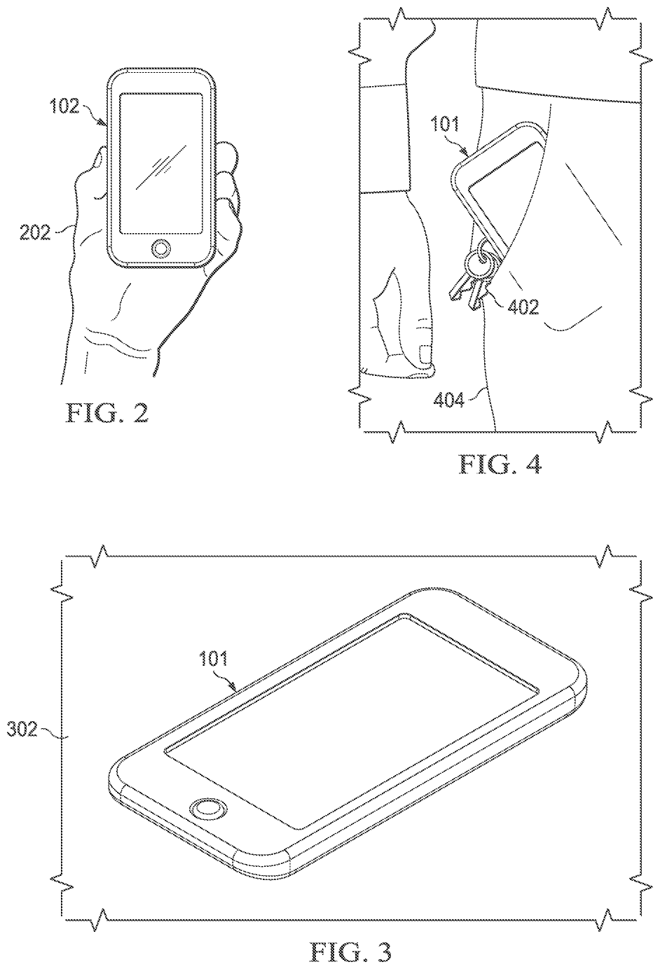

FIG. 2 depicts electronic device 102 being held in hand 202 by a user. In this position, undesired audio sounds as described in the Background section of this application are typically not generated in response to haptic effects output by linear resonant actuator 107.

FIG. 3 illustrates electronic device 102 resting on a table 302, in accordance with embodiments of the present disclosure. FIG. 4 illustrates electronic device 102 located in proximity to keys 402 in a pocket 404 of a user's clothing, in accordance with embodiments of the present disclosure. In the positions shown in FIGS. 3 and 4 (and other positions), when electronic device 102 plays a haptic effect, undesired audio sounds (such as a buzz or rattling sound) may be generated.

Accordingly, controller 103 may also be configured to sense an undesired audio sound caused by haptic vibration of linear resonant actuator 107, and may compensate or take other action to minimize or eliminate the undesired audio sound.

For example, controller 103 may be configured to detect a behavioral situation for electronic device 102 within its environment in which vibration of linear resonant actuator 107 may be non-linear, and thus may generate undesirable audio sounds. To perform such detection, controller 103 may receive sensor signals from one or more other components of mobile device 102 and determine therefrom the existence of the non-linear behavioral situation. Such sensor signals may include, without limitation, an electrical current through linear resonant actuator 107 (as sensed by electrical parameter sensor 111), an audio signal (as sensed by microphone 106), an acceleration signal (as sensed by accelerometer 109), and/or any other suitable sensor signal.

For example, a measured current or change in current through linear resonant actuator 107 may be indicative of a change in harmonic structure of electronic device 102, thus indicating presence of undesired audible vibration. To illustrate, a measured current may enable changes in a mechanical impedance of electronic device 102 to its environment to be detected. Hand-held operation of electronic device 102 may have a range of mechanical impedances. However, when electronic device 102 is in an undesirable, audible noise-generating position (e.g., not held in the user's hand), its quality factor or resonant frequency may change, and controller 103 may be able to detect such change by measuring one or more electrical parameters associated with linear resonant actuator 107, including a current flowing through it.

As another example, controller 103 may use a microphone signal generated by microphone 106 to detect an audio response of a haptic event, thus enabling controller 103 to determine whether an audible sound is generated as a result of a haptic event.

As a further example, controller 103 may use an acceleration signal generated by accelerometer 109 to determine if acceleration of electronic device 102 differs from an expected, desirable acceleration. In other words, accelerometer 109 may detect harmonics associated with a haptic event, and such detection may enable controller 103 to determine whether electronic device 102 is being held in a user's hand, or whether it is in an undesirable position such as that depicted in FIGS. 3 and 4.

In response to determining that electronic device 102 is in an undesirable position and is generating an audio sound in response to a haptic effect, controller 103 may take one or more actions. For example, in response to determining that electronic device 102 is in an undesirable position and is generating an audio sound in response to a haptic effect, controller 103 may attenuate (or cause amplifier 112 to attenuate) haptic input signal V_{IN}, substituting a different haptic playback waveform for haptic input signal V_{IN}, outputting a different mode of notification to the user other than haptic feedback (e.g., a desired audio or visual notification), and/or may cease generation of haptic effects.

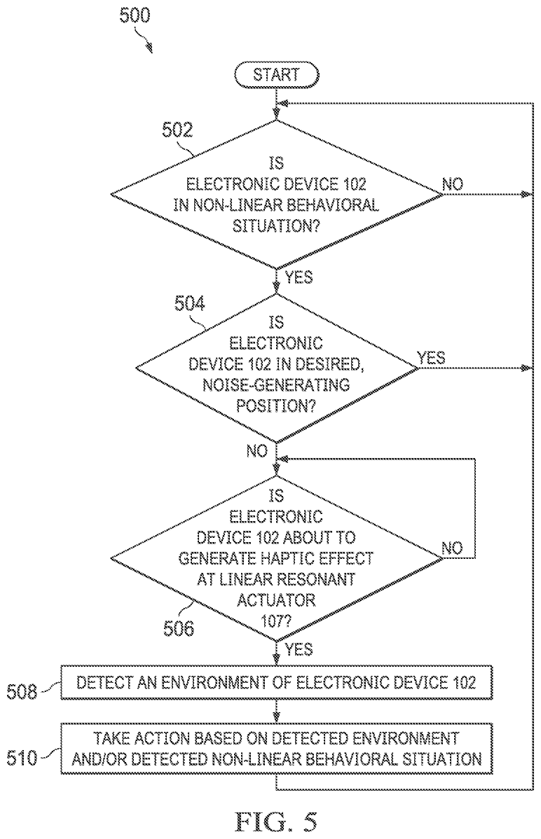

FIG. 5 illustrates a flow chart of an example method 500 for sensing and compensating for non-linear haptic vibration, in accordance with embodiments of the present disclosure. According to some embodiments, method 500 may begin at step 502. As noted above, teachings of the present disclosure may be implemented in a variety of configurations of electronic device 102. As such, the preferred initialization point for method 500 and the order of the steps comprising method 500 may depend on the implementation chosen.

At step 502, controller 103 may determine if electronic device 102 is in a non-linear behavioral situation for electronic device 102 within its environment. In other words, controller 103 may determine if one or more components of electronic device 102 are interacting in the environment of electronic device 102 such that a non-linear behavioral situation is created (e.g., sensor signals of electronic device 102 indicate a non-linear behavioral situation). If electronic device 102 is in a non-linear behavioral situation, method 500 may proceed to step 504. Otherwise, method 500 may return to step 502.

At step 504, based on the non-linear behavioral situation as determined by one or more sensor signals, controller 103 may determine whether electronic device 102 is in a desired, noise-generating position (e.g., based on whether sensor signals are within acceptable ranges). If electronic device 102 is in a desired, noise-generating position, method 500 may proceed again to step 502. Otherwise, method 500 may proceed to step 506.

At step 506, controller 103 may determine if electronic device 102 is about to generate a haptic effect at linear resonant actuator 107. If electronic device 102 is about to generate a haptic effect at linear resonant actuator 107, method 500 may proceed to step 508. Otherwise, method 500 may proceed again to step 506.

At step 508, electronic device 102 may detect an environment of electronic device 102. An environment of electronic device 102 may represent sensor signals measured in response to playback of a haptic effect to determine if an undesirable sound has generated in response to the haptic effect. Thus, while steps 502 and 504 may represent “predictive” indicators of whether undesirable noise may occur in response to a haptic effect, step 508 represents an indicator of whether undesirable noise has occurred.

At step 510, controller 103 may take an action based on the detected environment and/or detected non-linear behavioral situation. As mentioned above, such action may include controller 103 attenuating (or causing amplifier 112 to attenuate) haptic input signal V_{IN}, substituting a different haptic playback waveform for haptic input signal V_{IN}, outputting a different mode of notification to the user other than haptic feedback (e.g., a desired audio or visual notification), and/or ceasing generation of haptic effects.

After completion of step 510, method 500 may proceed again to step 502.

Although FIG. 5 discloses a particular number of steps to be taken with respect to method 500, method 500 may be executed with greater or fewer steps than those depicted in FIG. 5. In addition, although FIG. 5 discloses a certain order of steps to be taken with respect to method 500, the steps comprising method 500 may be completed in any suitable order.

Method 500 may be implemented in whole or part using controller 103, and/or any other system operable to implement method 500. In certain embodiments, method 500 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A method comprising:
determining whether an electronic device having a haptic transducer is in an undesired noise-generating position; and
responsive to the electronic device being in the undesired noise-generating position, modifying playback of a haptic effect at the haptic transducer.

2. The method of claim 1, wherein determining whether the electronic device is in the undesired noise-generating position comprises:
detecting a non-linear behavioral situation for the electronic device within an environment of the electronic device; and
based on the detected non-linear behavioral situation, determining whether the electronic device is in the undesired noise-generating position.

3. The method of claim 2, further comprising modifying playback of the haptic effect at the haptic transducer based on the detected non-linear behavioral situation.

4. The method of claim 1, further comprising determining whether the haptic transducer is about to play back the haptic effect, and wherein modifying playback of a haptic effect at the haptic transducer occurs responsive to determining the haptic transducer is about to play back the haptic effect.

5. The method of claim 1, further comprising:
detecting an environment of the electronic device; and
modifying playback of the haptic effect at the haptic transducer based on the environment of the electronic device.

6. The method of claim 5, wherein determining the environment of the electronic device is based on a microphone signal generated by a microphone of the electronic device indicative of whether undesired audio sounds are generated by the haptic transducer.

7. The method of claim 1, wherein determining whether the electronic device is in the undesired noise-generating position is based on an accelerometer signal generated by an accelerometer of the electronic device.

8. The method of claim 1, wherein the undesired noise-generating position is the electronic device placed upon a table.

9. The method of claim 1, wherein the undesired noise-generating position is the electronic device placed in contact with a metal object.

10. A system comprising:
an input configured to receive an indication of whether an electronic device having a haptic transducer is in an undesired noise-generating position; and
control circuitry configured to:
determine whether the electronic device is in an undesired noise-generating position; and
responsive to the electronic device being in the undesired noise-generating position, modify playback of a haptic effect at the haptic transducer.

11. The system of claim 10, wherein determining whether the electronic device is in the undesired noise-generating position comprises:
detecting a non-linear behavioral situation for the electronic device within an environment of the electronic device; and
based on the detected non-linear behavioral situation, determining whether the electronic device is in the undesired noise-generating position.

12. The system of claim 11, further comprising modifying playback of the haptic effect at the haptic transducer based on the detected non-linear behavioral situation.

13. The system of claim 10, further comprising determining whether the haptic transducer is about to play back the haptic effect, and wherein modifying playback of a haptic effect at the haptic transducer occurs responsive to determining the haptic transducer is about to play back the haptic effect.

14. The system of claim 10, further comprising:
detecting an environment of the electronic device; and
modifying playback of the haptic effect at the haptic transducer based on the environment of the electronic device.

15. The system of claim 14, wherein determining the environment of the electronic device is based on a microphone signal generated by a microphone of the electronic device indicative of whether undesired audio sounds are generated by the haptic transducer.

16. The system of claim 10, wherein determining whether the electronic device is in the undesired noise-generating position is based on an accelerometer signal generated by an accelerometer of the electronic device.

17. The system of claim 10, wherein the undesired noise-generating position is the electronic device placed upon a table.

18. The system of claim 10, wherein the undesired noise-generating position is the electronic device placed in contact with a metal object.
